(19) United States
(12) Patent Application Publication
(10) Pub. No.: US 2014/0366694 A1
(43) Pub. Date: Dec. 18, 2014

(54) METHOD AND APPARATUS FOR SUBSTANTIALLY SIMULTANEOUSLY SCORING A WORKPIECE FROM OPPOSED SIDES

(71) Applicant: OBERG INDUSTRIES, Freeport, PA (US)

(72) Inventors: MATTHEW RAYMOND KONIECZNY, BUTLER, PA (US); RICHARD GENE DeCROO, SARVER, PA (US)

(73) Assignee: OBERG INDUSTRIES, Freeport, PA (US)

(21) Appl. No.: 14/299,322

(22) Filed: Jun. 9, 2014

Related U.S. Application Data
(60) Provisional application No. 61/836,229, filed on Jun. 18, 2013.

(51) Int. Cl. B26F 1/40

(52) U.S. Cl. CPC B26F 1/40
USPC 83/27; 83/51; 83/531

(57) ABSTRACT

A method and related apparatus for scoring a workpiece are disclosed. A first scoring die has a score section structured to score a workpiece in a predetermined pattern, a second scoring die having as a score section structured to score a workpiece in a predetermined pattern substantially identical to the predetermined pattern of the first score scoring die. In operation the method and apparatus align the first scoring die and second scoring die and score the workpiece from opposite sides to effect complete or substantially complete reduction of the workpiece in a predetermined path to define a part. The workpiece will generally be a sheet. The scoring dies will each have score sections having one surface configured to be substantially perpendicular to the longitudinal axis of the workpiece and an adjacent angularly disposed surface structured to be adjacent to the scrap being produced by the scoring operation.

### CROSS-REFERENCE TO RELATED. APPLICATIONS.

This application claims priority under 35 U.S.C. §119(e) from U.S. provisional patent application No. 61/836,229, entitled “A Method and Apparatus for Substantially Simultaneously Scoring a Workpiece From Opposed Sides” and filed on Jun. 18, 2013 the contents of which are incorporated herein by reference.

### BACKGROUND OF THE INVENTION

1. Field of the Invention

The present invention is directed toward a method and associated apparatus for simultaneously scoring a workpiece from opposite sides to effect complete or substantially complete reduction of the thickness of the workpiece by effecting scoring in a predetermined path substantially simultaneously from both sides.

2. Description of the Prior Art

It has been known to employ a stamping press having a reciprocating ram cooperatively operatively associated with a platen. Such a press may employ a ram which is reciprocated by mechanical means or, in the alternative, by hydraulic means. By securing an appropriate die to the ram and introducing a workpiece between the die and a lower platen of the workpiece, which may be sheet-like, may be punched out of the workpiece.

Among the known systems for effecting such fabrication, is the use of a steel rule die secured to the ram and a platen structured to underlie the workpiece. The steel rule die is used in cooperation with an underlying platen cuts material against a solid platen. The steel rule die can be likened to a razor blade. One of the shortcomings of the steel rule die is that it cannot reliably achieve fine tolerances. Other shortcomings of steel rule tooling is that, as the blades are a standard/purchased item the geometry of the cutting blade is somewhat limited to standard bevels. Also, the set-up of a new steel rule die is done by shimming areas that do not cut on the initial cycle of the press. This shimming effort is repeated until the tool is cutting the entire profile of the cut. This requires someone familiar with the technology to “tweak” the tool. It has also been known to use in stamping operations, complimentary male and female dies where close tolerances are required, however, the punch and die tend to cause wear and at times, failure due to the punch becoming misaligned with the cooperating scoring die. This results in the need to replace parts with the accompanying undesirable down time of the press. Employing such a system for scoring tends to result in the punch and die ultimately being ruined. A further problem with this approach is that when this system is employed to cut more brittle plastic, the workpiece tends to fracture on the die side, thereby creating an undesirable rough edge.

One of the problems with prior art approaches to stamping of materials such as, for example, in plastics, is the creation of undesirable “angel hair”, i.e., the cutting process leaving fine whiskers of plastic material. For many uses, this is highly undesirable. A smooth edge condition is desired for many uses such as, for example, credit cards and security ID cards. In traditional male-female tooling the nature of the stamping process you will have a cut on one side of your part which will result in a rollover or rounded edge. On the opposite side you will have a break which results in a sharp or burred edge. A further shortcoming of many prior an practices is the creation of an excess amount of scrap material.

In spite of the foregoing known practices, there remains a very real and substantial need for a process for stamping semifabricated or fabricated parts from a workpiece, such as a sheet of material, while eliminating or substantially reducing the hereinbefore described problems.

### SUMMARY OF THE INVENTION

While, for simplicity of disclosure herein, reference will be made to an “upper scoring die” and a “lower scoring die”, the reference to “upper” and “lower” will not be limited to a generally vertical orientation of the path of relative, reciprocation of the dies which can be positioned for any desired orientation of the path of reciprocation so long as the dies cooperate to achieve the desired scoring objective of the present invention.

The present invention has met the above described need. In one embodiment, a method of scoring a workpiece includes providing a upper scoring die having a score section structured to score a workpiece in a predetermined pattern. It also provides a lower scoring die having a score section structured to score a workpiece in a predetermined pattern with the pattern being substantially identical to the predetermined pattern of the upper scoring die. The upper scoring die and lower scoring die are positioned on opposite sides of the workpiece with the score sections substantially aligned with each other. The workpiece is positioned between the upper and lower scoring dies and relative closing movement between the upper and lower scoring dies is effected to cause the score sections to cooperate with each other to score the workpiece from opposite sides to completely or substantially completely reduce the thickness of the workpiece along the predetermined path of reciprocation. One may remove the part defined by the scored section which declines the part from the workpiece during the practice of the method or, in the alternative, retain a small amount of residual metal such that one or more subsequent operations may be performed on the part before separation of the part from the workpiece.

The score section cross-sectional configuration is preferably generally triangular with a substantially planar first face oriented generally perpendicular to the longitudinal axis of the workpiece being positioned adjacent to what will become the finished part. A substantially planar second face is angularly disposed with respect to the planar first face. The substantially planar second face will face what will become the scrap portion of the workpiece. After scoring, the workpiece may then advanced so as to permit the next cycle of scoring on an adjacent portion of the workpiece.

The apparatus of the present invention may include a stamping press having a reciprocating ram to which an upper scoring die of the type hereinbefore described is secured and a bolster plate to which the lower scoring die as hereinbefore described, is secured. With the substantially aligned upper and lower dies, relatively closing movement between the ram and the bolster plate will cause simultaneous scoring of the workpiece from opposite directions thereby creating a complete or substantially complete reduction in thickness along the predetermined path.

It is an object of the present invention to provide an efficient method and associated apparatus for scoring a workpiece to precise tolerances by simultaneously effecting scoring from opposite sides of the workpiece.

It is another object of the present invention to provide such a method and apparatus which can adhere to close tolerances and be effective in cutting difficult material such as plastic, metals and laminated sheet-like materials, while minimizing downtime of the system.

It is a further object of the present invention to provide cooperating opposed scoring dies, each of which have substantially the identical predetermined scoring pattern in such a way as to minimize undesired formation of angel hair in severing certain plastics from a sheet-like workpiece.

It is a further object of the invention to so configure the scoring tools as to provide surface to surface contact between the scoring die and the portion of the workpiece which will become the finished part and an adjacent angularly oriented scoring die face which contacts the side of the workpiece which will become scrap.

It is a further object of the invention to provide such a system wherein tool wear and resulting expense and downtime are minimized.

It is yet another object of the invention to provide such a scoring system wherein plastic parts, such as credit cards, identification cards and the like severed from the workpiece will have peripheral edges which are rounded on the top and bottom edges.

These and other objects of the invention will be more fully understood from the following description of the invention on reference to the drawings appended hereto.

### BRIEF DESCRIPTION OF THE DRAWINGS

FIG. 1 is top plan view showing a workpiece entering the press tooling (such as that illustrated in FIGS. 13 and 14) and emerging from the press tooling.

FIG. 2 shows a top plan view of parts which have been severed from the workpiece shown in FIG. 1.

FIG. 3 is an elevation of a view of a stamping press containing the scoring dies of the present invention and functioning to score a workpiece from opposite sides.

FIG. 4 is an elevational view showing a punch and die of the present invention with a workpiece disposed therebetween.

FIG. 5 is an elevational view of the die and workpiece of FIG. 4 with the die in closed position effecting scoring of the workpiece.

FIG. 6 is a partial cross-sectional illustration showing the opposing scoring dies and the finished part and scrap portions.

FIG. 7 is a perspective view of a lower die of the present invention structured to score a workpiece in a rectangular pattern with curved corners.

FIG. 8 is an end top plan view of the die of FIG. 7.

FIG. 9 is a right side view of the scoring die of FIG. 8.

FIG. 10 is a partial view in elevation showing one of the scoring tools.

FIG. 11 is a cross-sectional illustration showing a section of the die.

FIG. 12 is a top plan view of the punch employed in the present invention.

FIG. 13 is an elevational view of the punch and die of the present invention.

FIG. 14 is a perspective view of the punch and die of the present invention.

### DESCRIPTION OF THE PREFERRED EMBODIMENTS

As employed herein the term “workpiece” shall refer to a sheetlike material which is structured to pass between scoring dies of the present invention and have discrete portions thereof which define a desired fabricated or semifabricated part removed by the scoring system of the present invention or, in the alternative, to have the scoring system of the present invention result in scoring which leaves a small residual so as to facilitate subsequent removal of the individual part with or without subsequent processing. The workpiece may advantageously be provided as flat sheet or coil stock or formed plastic shapes, for example.

As will be described in greater detail hereinafter, the press will have a reciprocating ram or punch to which one scoring die will be secured and a stationary bolster plate to which the second scoring die will be secured. The workpiece may be fed through the press by any conventional means well known to those skilled in the art, Similarly, when complete severance is effected, those skilled in the art will be well acquainted with means for collecting the separated parts.

A prime focus of the present invention is to provide opposed scoring tools which are configured in a substantially identical predetermined pattern such that movement of the ram establishes relative closing movement between the scoring dies and creates scoring action on the workpiece from opposite sides wherein the aligned score tools simultaneously penetrate the workpiece, thereby completely severing the workpiece or, if desired, retaining a minor residual thickness and, in both cases, avoiding a direct die to die contact.

The workpiece may be composed of a resinous plastic material such as, for example, polycarbonate, metal, or laminated materials including a combination of materials such as, for example, layers of different plastics or layers consisting of different materials adhesively bonded to each other. The composite material may, for example, consist of one or more pairs of plastic layers with interposed adhesive material such as pressure sensitive materials.

The properties of the workpiece may vary, and depending on factors such as, for example, the workpiece material and part to be made, as well as depth of scoring. In general, the system will preferably operate on workpiece materials having a thickness of about 0.0005 to 0.125 inch and preferably about 0.005 to 0.060 inch.

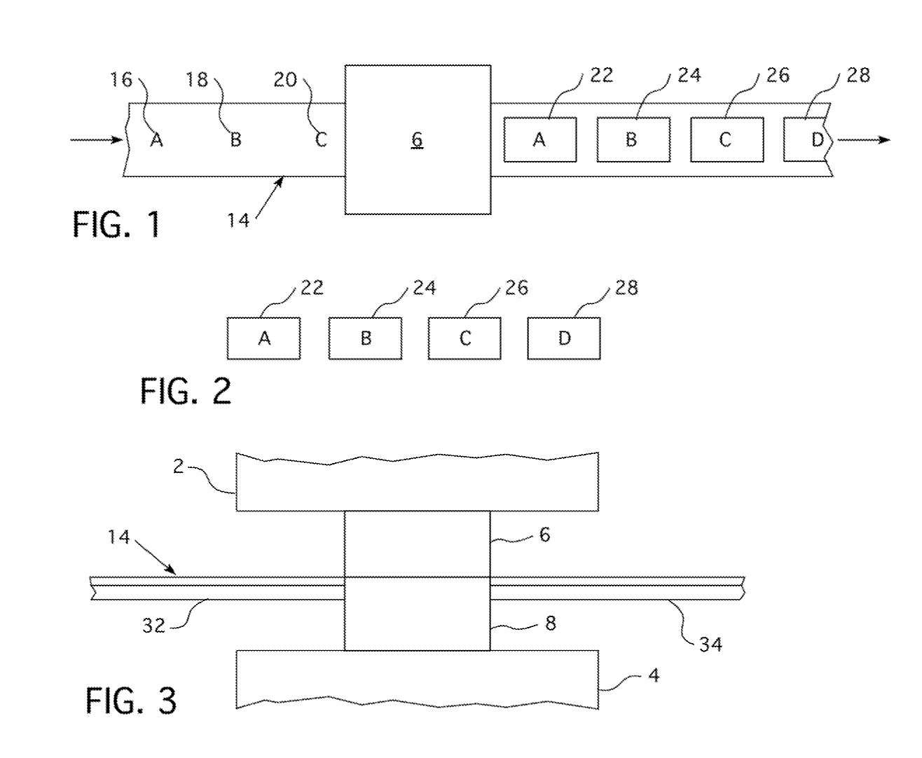

Referring to FIGS. 1 through 3, there is shown portions of what may be a conventional stamping press having a ram 2 and an underlying bolster plate 4, an upper die 6 is fixedly secured to a lower portion of ram 2 and a lower die 8 is fixedly secured to the upper surface of the bolster plate 4. The dies 6 and 8 each have a score section (not shown in these figures) which is structured to score a workpiece in a predetermined pattern with each die having substantially identical predetermined patterns such that, when a workpiece is interposed between the upper scoring die 6 and lower scoring die 8 and the dies 6,8 are in a closed position as shown in FIG. 3, the workpiece will be scored in the identical region from both above and below simultaneously.

The workpiece 14 travels between the dies in the direction indicated by the arrows in FIG. 1. The movement of the workpiece 14 may be achieved through any conventional means well known to those skilled in the art. Predetermined stoppage of workpiece movement will be effected in order for the scoring operation to take place. After that the upper scoring die 6 and lower scoring die 8 are separated through upward movement of the ram 2 with further movement and stoppage of the workpiece 14 occurring at an indexed location for the next scoring operation.

As shown in schematically in FIG. 1, depending upon the part to be produced, the workpiece may be provided with regions such as A, B, C indicated by reference numbers 16,18 and 20, which may represent text graphics or a combination thereof, in a desired format which will be present on the part severed from the workpiece, When that is the sole information to be provided on the part, the scoring operation will generally be structured to completely sever the part from the workpiece. Where, on the other hand, it is contemplated that additional information might be added, such as, for example, the initial graphics and text 16, 18, 20 providing, a form with additional and/or personalized credit card information to be added later. Generally, the scoring operation will result in leaving a minimal amount of residual material such that the subsequent operation to customize the credit card or other article, may be accomplished before complete part severance has been achieved. In the form shown, the products indicated by reference numbers 22, 24,26,28 have passed through the scoring operation. As shown in FIG. 3, the entering portion of the workpiece 14 is supported by a table 32 and the exiting portion of the workpiece is supported by table 34.

As shown in FIG. 2 the products 22,24,26,28 have been completely severed from workpiece 14. The severed parts may advantageously be stacked in a shute after severance or permitted to free-fall into underlying bins or if on an appropriate support member, may be transported and the workpiece openings from which they have been severed.

It will be appreciated while the present example involves a rectangular configuration which may be useful in credit cards, identification cards and other uses, the invention is not so limited and they assume a number of closed shaped configurations such as squares or circles, as well as a wide variety of other configurations.

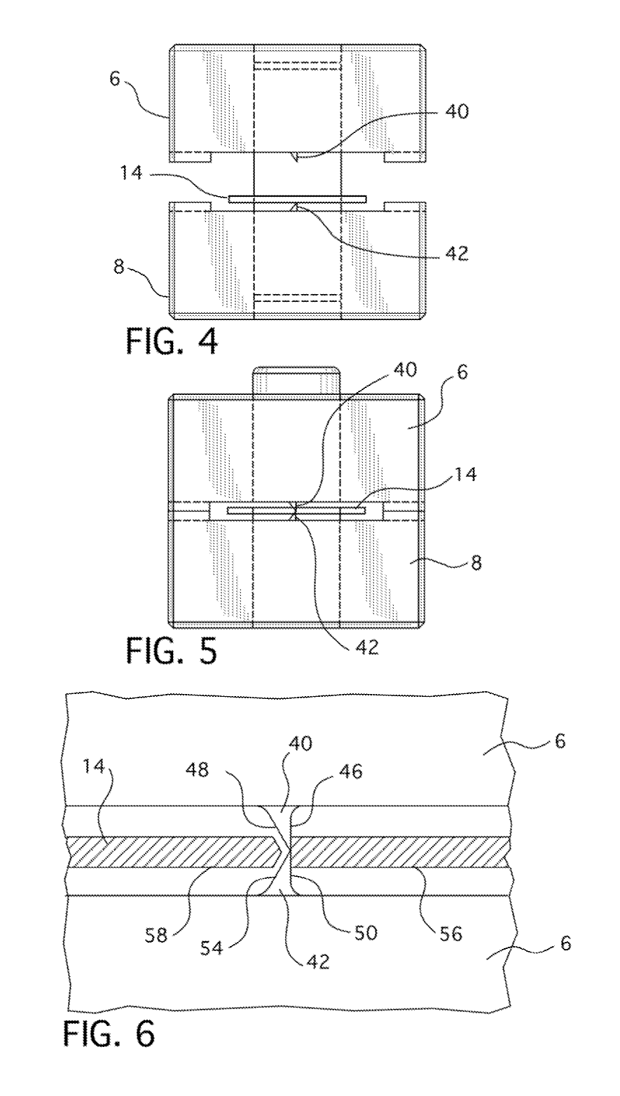

Referring to FIGS. 4 through 6, shown in FIGS. 4, are the upper die or a punch 6 and lower die 8 with the downwardly projecting score sector 40 and upwardly projecting score sector 42 and the uncut workpiece 14. FIG. 5 shows the dies 68 in the closed position. An enlarged detail of a portion of FIG. 5 is shown in FIG. 6. As seen in FIG. 6, the upper scoring die 6 has its score section 40 shaped in generally triangular configuration with face member 46 being generally planar and oriented generally perpendicular with respect to the longitudinal axis of the workpiece 14 (which axis would be perpendicular to the plane of the paper). The adjacent face 48 is generally planar and extends angularly away from face 46. Similarly, face 50 of score section 42 is oriented generally perpendicular to the longitudinal axis of the workpiece 14. Face 54 is generally planar and angularly disposed with respect to face 50. It will be noted that faces 40 and 42 are against what will become finished part 56 and angular faces 48,54 are adjacent to what will become scrap 58. The angular faces 48,54 serve to provide structural strength to the portion to be scored in order to withstand the farces required to cut into the material during scoring. It also provides a wedging action to assist in the cutting of the material.

Referring still FIG. 6, in prior art, traditional male-female tooling in a stamping process, the cut on one side of the material will result in rollover or rounded edge and on the opposite side, there would tend to be a sharp or burred edge. By contrast, by the system of the present invention, with scoring being achieved from both sides of the workpiece, this results in a rounded edge as both surfaces are approached by a punch type edge.

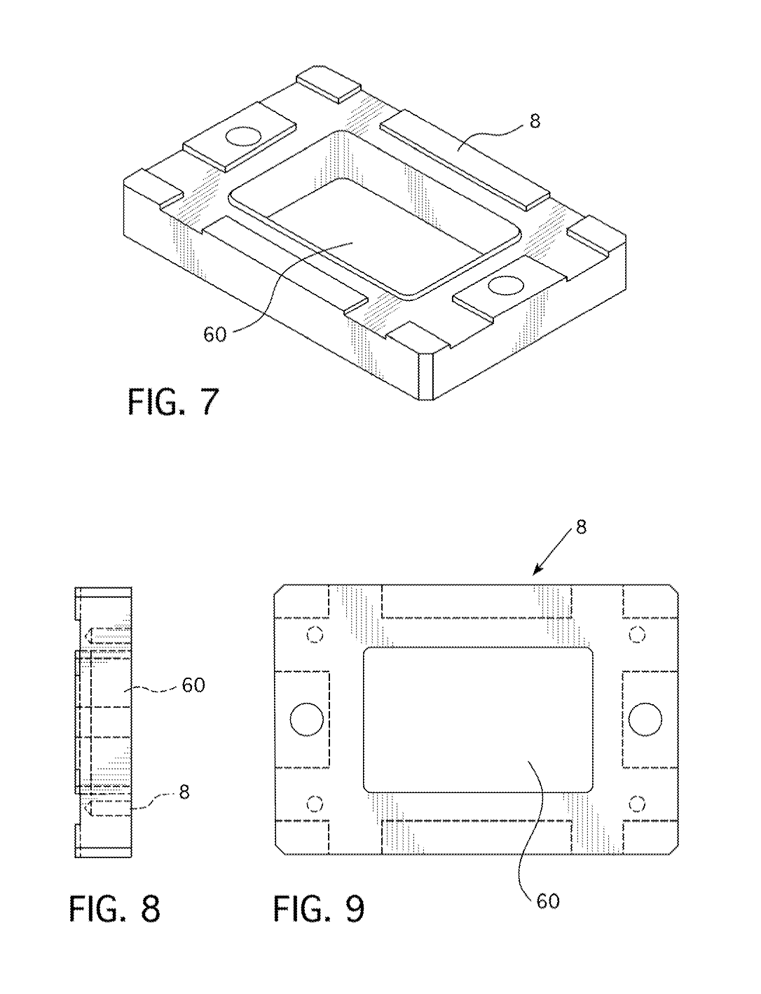

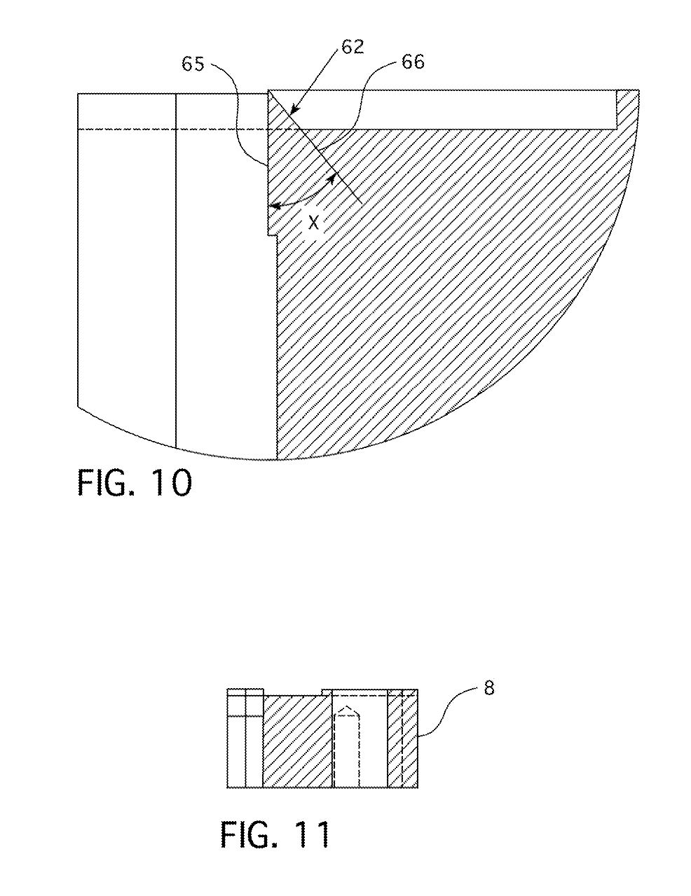

FIGS. 7 through 9 show the lower scoring die 8 which has an opening 60 within which the scoring tool will be retained. A detail of the portion of the scoring tool 62 of the present invention is shown in FIG. 10. It will be seen that the tip of the scoring tool 62 is at the line where substantially planar first face 65 which will be in surface to surface contact with the portion of the workpiece which will become the part and the substantially planar angular second face 66 which is angularly disposed with respect to face 65, has an included angle X which, in the form shown, will generally be about 10 to 45 degrees and, most preferably, be about 20 to 40 degrees.

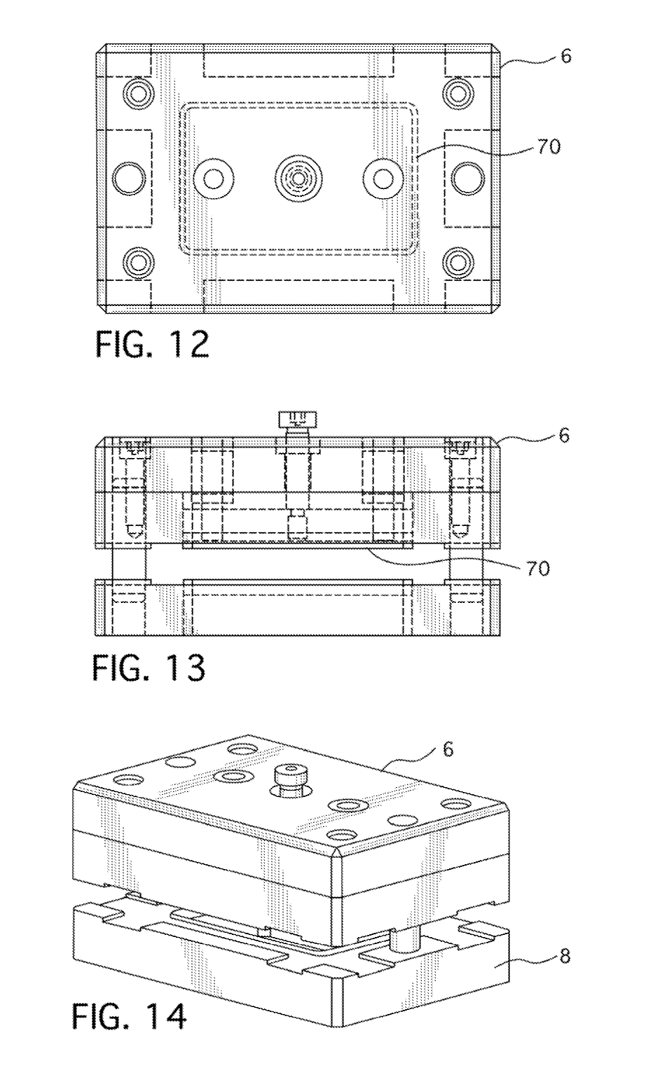

Referring to FIGS. 12 through 14, there is shown the upper scoring die or punch 6 and the lower scoring die 8. FIG. 12 shows the generally rectangular part ejector 70 of the upper die 6. In the form shown, in FIGS. 12 through 14, the ejector is structured in prototype fashion to be manually operated in production tools, however, as will be well known to those skilled in the art, the ejector would be activated by means such as pneumatics or servomechanisms, as well as parts made from paper, cardboard, plastic and steel. It will be appreciated that while the example shown in the present case illustrates production of a single part with each scoring operation, depending upon the size of the dies and the size of the parts, two or more parts may be produced simultaneously with one stroke of the ram. These parts may be the result of side by side scoring or simultaneous scoring of a part which is disposed forwardly of another, or combinations of both.

It will be appreciated that the present invention provides an effective method and associated apparatus for solving the hereinbefore described problems. The system may be used to produce a wide variety of products including plastic cards such as credit cards, security cards, identification cards, passports, hotel keys and the like, metal parts, parts from laminated materials. Also, the space where multiple parts are scored side-by-side, the spacing between them may be reduced so as to minimize the amount of scrap produced by the process.

Whereas particular embodiments of the invention have been described herein, for purposes of illustration, it will be evident to those skilled in the art that numerous variations of the details may be made without departing from the invention as defined in the appended claims.

What is claimed is:

1. A method of scoring a workpiece comprising,
providing a first scoring die having a score section structured to score a workpiece in a predetermined pattern,
providing a second scoring die having a score section structured to score a workpiece in a predetermined pattern which is substantially identical to said predetermined pattern of said first scoring die,
positioning said first scoring die and said second scoring die on opposite sides of said workpiece with said first scoring die and said second scoring die having said score sections substantially aligned with each other,
positioning said workpiece between said first scoring die and said second scoring die,
scoring said workpiece by effecting relative closing movement between said first scoring die and second scoring die to cause each score section to cooperate with the other said score section to score said workpiece from opposed sides to effect at least substantially complete reduction in the thickness of said workpiece along said predetermined path to thereby define said part by said scoring.

2. The method of claim 1 including,
effecting by said method complete separation of said part from the remainder of said workpiece.

3. The method of claim 1 including,
retaining in said workpiece sufficient residual material between said score sections such that said part remains secured to said workpiece.

4. The method of claim 1 including,
employing a workpiece which is an elongated sheet.

5. The method of claim 4 including,
employing as said workpiece a sheet having thickness of about 0.0005 0.125 inch.

6. The method of claim 1 including,
providing on said workpiece predetermined markings selected from the group consisting of text, graphics and both graphics and text.

7. The method of claim 1 including,
each said score section having a generally triangular configuration in cross section with an apex of each said generally triangular shaped score section coming close to contacting the other said score section during said scoring.

8. The method of claim 7 including,
one face of each said score section being oriented generally perpendicular to the longitudinal axis of the workpiece.

9. The method of claim 8 including,
a second face of each said score section having an angular face oriented at an angle with respect to said one face.

10. The method of claim 9 including,
the included angle between said angular face and said first face being about 20 to 40 degrees.

11. The method of claim 10 including,
said one face of said score section being adjacent to the portion of the workpiece which will become said part, and
said angular face of said score section being adjacent to the portion of said part which will become scrap.

12. The method of claim 1 including,
each said predetermined pattern being a closed shape.

13. The method of claim 12 including,
said closed shape being generally rectangular.

14. The method of claim 13 including,
said closed shape being generally square.

15. The method of claim 12 including,
said closed shape being generally circular.

16. The method of claim 1 including,
said workpiece composed of a material selected from the group consisting of a synthetic resin, metal, cardboard, paper and a laminate composed of more than one layer of plastic material.

17. The method of claim 16 including,
said workpiece having a thickness prior to scoring of about 0.005 to 0.060 inch.

18. The method of claim 3 including,
subsequent to said scoring performing an additional operation on said part, and
thereafter separating said part from the remainder of said workpiece.

19. The method of claim 1 including,
advancing said workpiece and repeating the process to score additional portions of said workpiece to create additional said parts employing said first scoring die and said second scoring die.

20. The apparatus of claim 1 including,
providing a plurality of pairs of said first scoring dies and a cooperating plurality of said second scoring dies, and
scoring a plurality of sections of said workpiece to create a plurality of said parts substantially simultaneously,

21. Apparatus for scoring a workpiece comprising,
a press having a reciprocating ram and a bolster plate,
a first scoring die having a score section structured to score a workpiece in a predetermined pattern secured to said ram,
a second scoring die having a score section structured to score a workpiece in a predetermined pattern which is substantially identical to said predetermined pattern of said first scoring die secured to said bolster plate,
said score section of said first scoring die and said score section of said second scoring die having substantially identical said predetermined patterns,
said first scoring die score section being aligned with said second scoring die score section such that effecting relative closing movement between said first scoring die and said second scoring die with an interposed workpiece will cause said scoring sections to effect complete or substantially complete reduction in the thickness of said workpiece along said predetermined path by scoring said workpiece from opposite sides to thereby define the part to be made.

22. The apparatus if claim 21 including,
said apparatus structured to effect complete separation of said part from the remainder of said workpiece.

23. The apparatus of claim 21 including,
said apparatus structured to retain sufficient residual material between said score sections such that said part remains secured to said workpiece.

24. The apparatus of claim 22 including,
said apparatus structured to function as a stamping press structured to have an elongated sheet as a workpiece.

25. The apparatus of claim 21 including,
each said score section having a generally triangular configuration in cross-section with an apex such that each said triangular shaped scoring section is structured to come close to but does not contact the other said scoring section during scoring of said workpiece.

26. The apparatus of claim 25 including,
one face of each said scoring section being, structured to be oriented generally perpendicular to the longitudinal axis of the workpiece during a scoring operation.

27. The apparatus of claim 26 including,
the score portion face adjacent said one face being an angular face oriented at an angle with respect to said one face.

28. The apparatus of claim 27 including,
the included angle between said one face and said angular face being about 20 to 40 degrees.

29. The apparatus of claim 27 including,
said one face of said score section being structured to be disposed adjacent to the portion of the workpiece which will become the finished part and said angular face of said score section structured to be disposed adjacent to the portion of said finished part which will become scrap.

30. The apparatus of claim 21 including,
said predetermined pattern of said first scoring die score section and said second scoring die score section each having a closed shape.

31. The apparatus of claim 30 including,
said shape being generally rectangular.

32. The apparatus of claim 30 including,
said shape being generally square.

33. The apparatus of claim 30 including,
said shape being generally circular.

34. The apparatus of claim 21 including,
said apparatus structured to operate on a workpiece composed of a material selected from the group consisting of a synthetic resin, metal, cardboard, paper and a laminate composed of more than one layer of plastic material.

35. The apparatus of claim 21 including,
said apparatus having a plurality of pairs of said first scoring dies and second scoring dies, whereby said apparatus can substantially simultaneously score more than one section of said workpiece.

36. The apparatus of claim 21 including said one face and said angular face each being substantially planar.
